(19) United States
(12) Patent Application Publication
(10) Pub. No.: US 2024/0274029 A1
(43) Pub. Date: Aug. 15, 2024

(54) Bow Hand Training Device for Teaching Orchestral Student how to Pronate the Bow Towards the Strings While Playing

(71) Applicant: Toby John Weston, West Linn, OR (US)

(72) Inventor: Toby John Weston, West Linn, OR (US)

(21) Appl. No.: 18/441,064

(22) Filed: Feb. 14, 2024

Related U.S. Application Data
(60) Provisional application No. 63/484,787, filed on Feb. 14, 2023.

(51) Int. Cl. G09B 15/06; G10G 7/00

(52) U.S. Cl. CPC G09B 15/06; G10G 7/00

(57) ABSTRACT

A bow hand training device for teaching orchestral students how to pronate the bow toward the strings while playing by using a device with multiple surfaces designed to facilitate appropriate from the contours of the device along with instructions on the device itself. The training device has a semi-circular surface which facilitates the appropriate wrapping of the user's fingers and a semi-circular shape with a cutout to facilitate the appropriate thumb bend and curled pinky.

### CROSS-REFERENCE TO RELATED APPLICATIONS

This application claims benefit to provisional application U.S. 63/484,787 filed on Feb. 14, 2023, and is incorporated in its entirety.

### BACKGROUND OF THE INVENTION

The present invention relates generally to a string instrument attachment device. More specifically, the present invention is a device that attaches to the bow of a string instrument to teach the user how to properly hold the bow.

Playing the violin and other string instruments within an orchestra utilizes a bow that interacts with the strings of the violin. To play the violin the musician holds the bow in one hand and holds the violin in another hand with the bow resting on the strings of the violin. To produce a sound the musician then moves the bow back and forth across the strings. Playing the violin with a bow requires a lot of practice and coordination, requiring the musician to control the bow while holding down notes with their other hand on the violin. To produce a quality sound the musician must hold the bow at a proper angle with respect to the violin. This technique in conjunction with a good ear and sense of rhythm, will allow the musician to produce an enjoyable sound from the violin as the musician moves the bow across the violin strings.

An objective of the present invention is to provide users with a bow hand training device, to help orchestral students ensure their hand is properly pronated when holding the bow. The present invention intends to provide users with a device that can be 3D printed and designed to be fitted to any standard violin or other string instrument bow. In order to accomplish that, a preferred embodiment of the present subject matter comprises a top side, a front side, and a rear side. Further, the top side connects the front and rear side around the bow of a violin. Thus, the present invention is a bow hand training device for teaching orchestral students how to pronate the bow towards the strings while playing a string instrument.

### SUMMARY OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. least one specification heading is required.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The present invention is a bow hand training device shaped to form in the hand and attach to the bow of the string instrument. The present invention seeks to provide users with a device that automatically pronates when placed upon the bow of the string instrument. In order to accomplish this the present subject matter comprises a top side that provides a surface for the four fingers of the musician to wrap around.

Further, the front side comprises various instructions for the user on how to hold the present invention. Additionally, the rear side ensures the musician is instructed where to place their thumb. Thus, the present invention is a bow hand training device for teaching orchestral students how to pronate the bow towards the strings while playing a string instrument.

### BRIEF DESCRIPTION OF DRAWINGS

FIG. 1 is a front view of one embodiment of the bow hand training device.

FIG. 2 is a top view of one embodiment of the bow hand training device.

FIG. 3 is a bottom view of one embodiment of the bow hand training device.

FIG. 4 is a rear view of one embodiment of the bow hand training device.

FIG. 5 is a perspective view of one embodiment of the bow hand training device.

FIG. 6 is a front view of an alternative embodiment of the bow hand training device.

FIG. 7 is a rear view of an alternative embodiment of the bow hand training device.

FIG. 8 is a top view of an alternative embodiment of the bow hand training device.

FIG. 9 is a bottom view of an alternative embodiment of the bow hand training device.

FIG. 10 is a perspective view of an alternative embodiment of the bow hand training device.

FIG. 11 is a side view of one embodiment of the bow hand training device being held by a user with the bow.

FIG. 12 is an underneath perspective view of one embodiment of the bow hand training device being held by a user showing the bent thumb connecting the present invention to the bow.

FIG. 13 is a side perspective view of an alternative embodiment of the bow hand training device being held by a user with the bow.

FIG. 14 is a rear perspective view the bow hand training device on a bow showing the Curled Pinky and grip location.

FIG. 15 is a side view of the bow hand training device pronating towards the strings on the stick of the bow.

FIG. 16 is a side view of an alternative embodiment of bow hand training device pronating towards the strings on the stick of the bow.

FIG. 17 shows a side view of one embodiment of the bow hand training device with an attached sticker to indicate the angle the user's fingers should wrap around the bow hand training device.

FIG. 18 shows a side perspective view of the bow hand training device with an attached sticker to indicate where the user's thumb should bend and where the user's pinky should curl.

FIG. 19 shows a top perspective view of the bow hand training device.

FIG. 20 shows a bottom perspective view of the bow hand training device.

FIG. 21 shows a sticker sheet which is designed to be attached to the bow hand training device and bow as a training aid.

FIG. 22 shows a side perspective view of the preferred embodiment of the bow hand training device with an attached sticker to indicate where the user's thumb should bend and where the user's pinky should curl.

FIG. 23 shows a preferred embodiment of a side view of one embodiment of the bow hand training device with an attached sticker to indicate the angle the user's fingers should wrap around the bow hand training device.

FIG. 24 is a top view of the preferred embodiment of the bow hand training device.

FIG. 25 is a bottom view of the preferred embodiment of the bow hand training device.

FIG. 26 is a side perspective view of the preferred embodiment of the bow hand training device being held by a user without the bow.

FIG. 27 is a bottom perspective view of the preferred embodiment of the bow hand training device being held by a user without the bow.

FIG. 28 is a rear perspective view of the preferred embodiment of the bow hand training device on a bow showing the Curled Pinky and grip location.

FIG. 29 is a bottom perspective view of the preferred embodiment of the bow hand training device being held by a user showing the bent thumb connecting the present invention to the bow.

FIG. 30 shows a perspective view of the preferred embodiment of the bow hand training device in use.

FIG. 31 shows a side view of the bow with the bow labels affixed to the bow.

FIG. 32 shows a side view of the bow with the Bend Thumb and Curl Pinky sticker affixed to the bow handle.

FIG. 33 shows a side view of the bow with the Wrap Fingers sticker affixed to the bow handle.

### DETAILED DESCRIPTION OF THE INVENTION

All illustrations of the drawings are for the purpose of describing selected versions of the present invention and are not intended to limit the scope of the present invention.

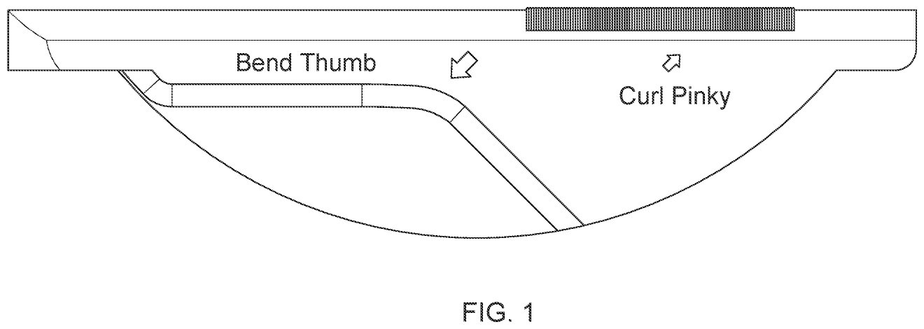

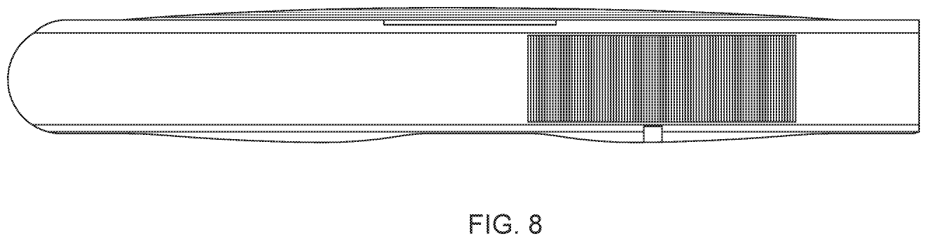

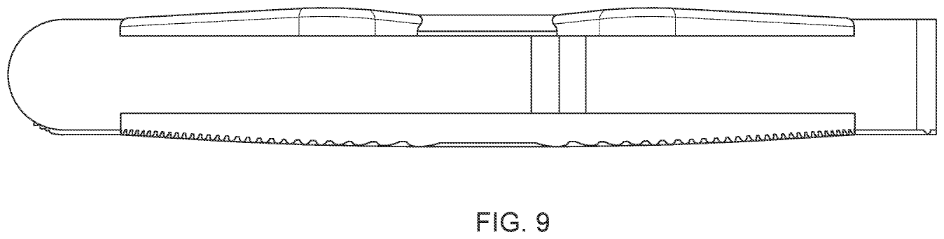

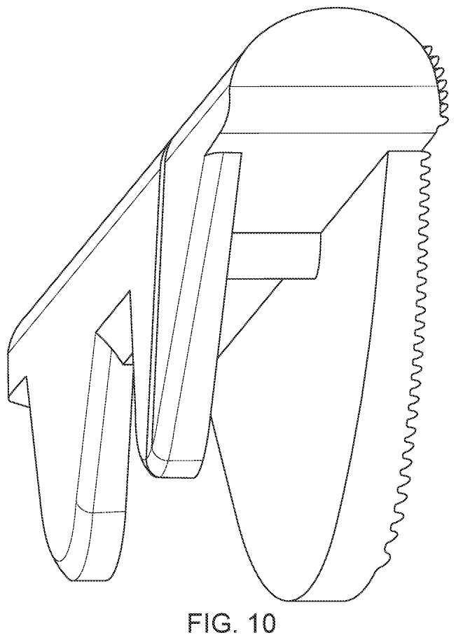

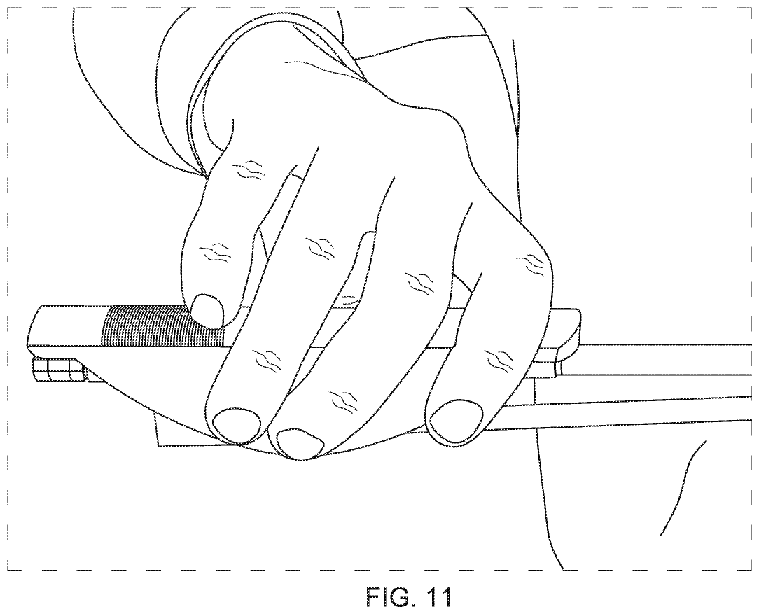

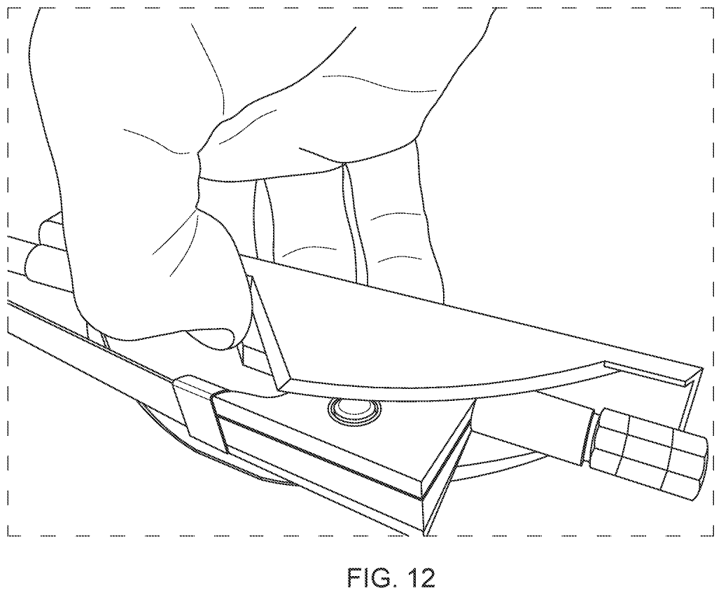

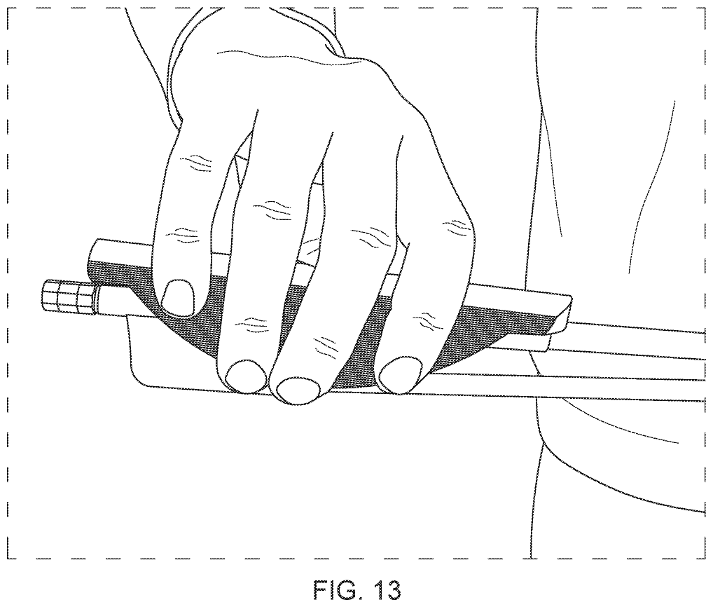

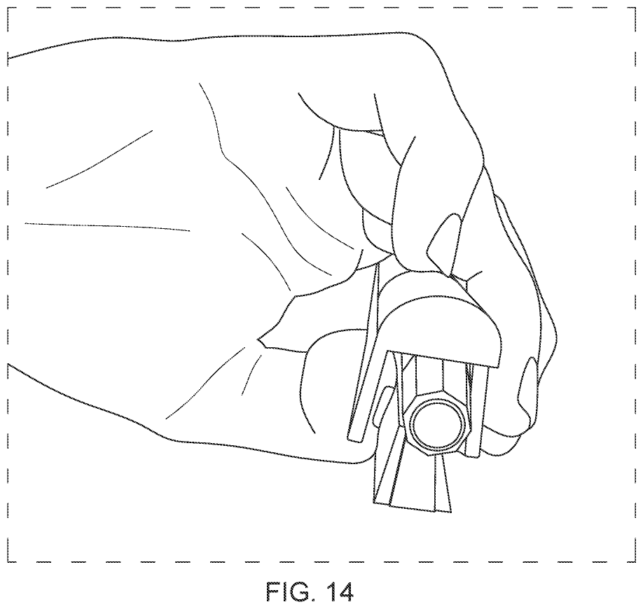

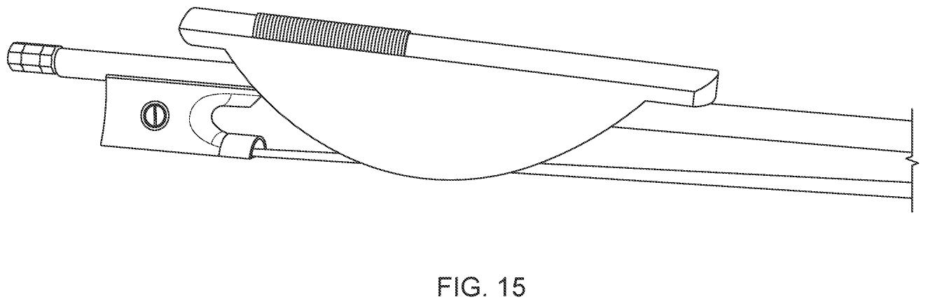

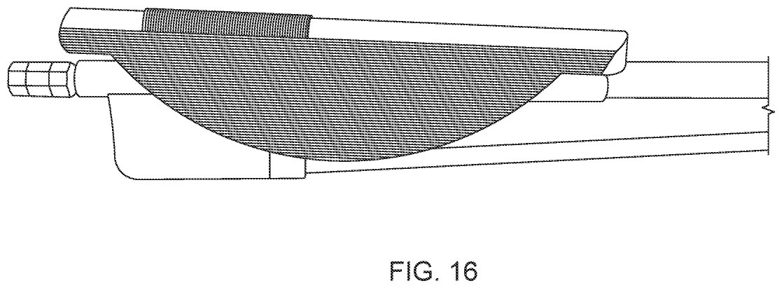

As shown in FIG. 1-21, the present invention is a bow hand training device that focuses on the proper pronating of the bow for correct bow holding. An objective of the present invention is to provide users with a device that automatically pronates the bow hand of the user as the present invention is attached to a bow of a string instrument as shown in FIG. 11.

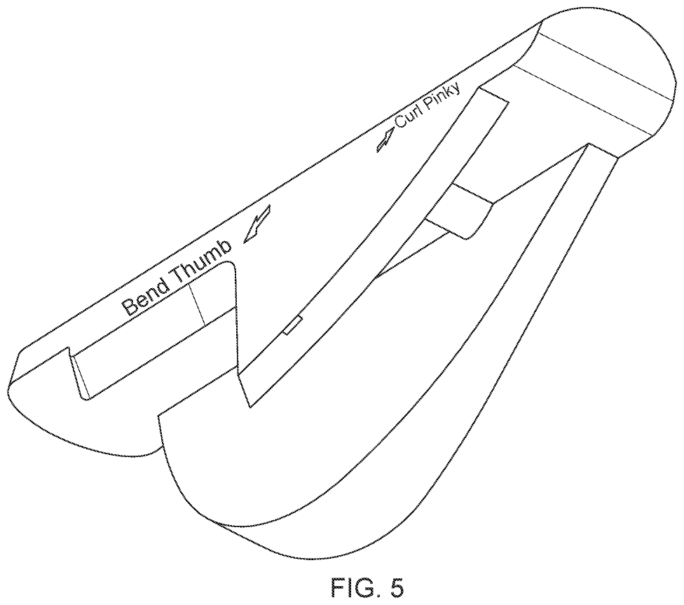

The present invention intends to provide users with a device that can be attached to various string instrument bows. To accomplish this the present invention comprises a top side, a front side, and a rear side. Many of these components allow for the musician to be instructed on how to properly hold the bow of a string instrument. The front side and the rear side are fixed to the top side along the upper sides of both the front side and the rear side to create an overall shape with an upside-down U-shaped cross section as seen in FIG. 5. Thus, the present invention is a bow hand training device for teaching orchestral students how to pronate the bow towards the strings while playing a string instrument.

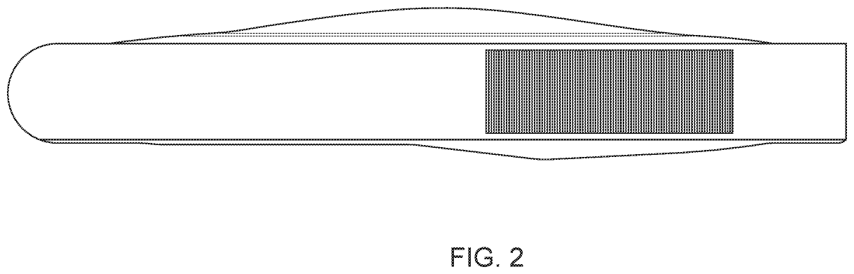

The present invention is positioned on the top side of the end of a bow of a string instrument. The present invention is preferably made with a lightweight plastic material but can be designed with wood and other materials. The top side is designed with a lightweight plastic material that extends the length of the present invention with a rectangular shape as seen from in FIG. 2.

In one embodiment the top side comprises a pinky grip, a curved surface, and a raised internal bump. The pinky grip is located on the upper side along the end of the top side as shown in FIG. 2. The pinky grip is designed with a plurality of ridges made with a material with a high coefficient of friction to provide a surface that grips the pinky finger. The curved surface extends along the upper side of the top side and is designed with a semi-circular cross-sectional shape.

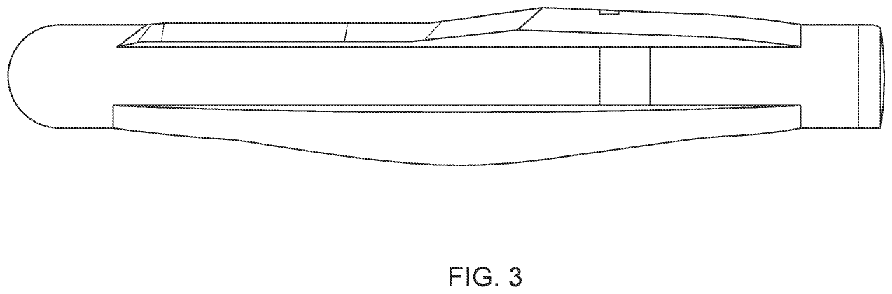

This design allows the musician to easily wrap their hand and fingers around the top side, Furthermore, the raised internal bump is positioned on the bottom surface of the top side. The raised internal bump is designed with a semi-cylindrical shape that traverses perpendicular to the front side shown in FIG. 3. The raised internal bump can also be designed with a triangular cross section. The raised internal bump allows the present invention to be positioned with a tilt encouraging the musician to have a pronated hand while using the present invention as seen in FIG. 11. It should be further noted that, the top side can be created in many various shapes and sizes and the pinky grip could be created in various ways while still staying within the scope of the present invention.

The front side connects with the top side along the upper side of the front side. The front side is designed with an oblong shape as shown in FIG. 1. In one embodiment the front side comprises a plurality of engravings and a curled edge. The plurality of engravings further comprises a pinky wording, a thumb wording, and a plurality of arrows. The pinky wording is positioned along the below the pinky grip displaying the words “Curl Pinky”.

Positioned offset the pinky wording is the thumb wording that displays the words “Bend Thumb” shown in FIG. 5. Positioned offset both the pinky wording and thumb wording is the plurality of arrows with one arrow pointing upwards towards the pinky grip with the other arrow pointing downwards towards the curled edge. These components instruct the musician where to place their thumb and fingers when holding the present invention. The curled edge is positioned on the bottom edge of the front side and curved downwards creating an ergonomic groove for the musician to place their thumb properly.

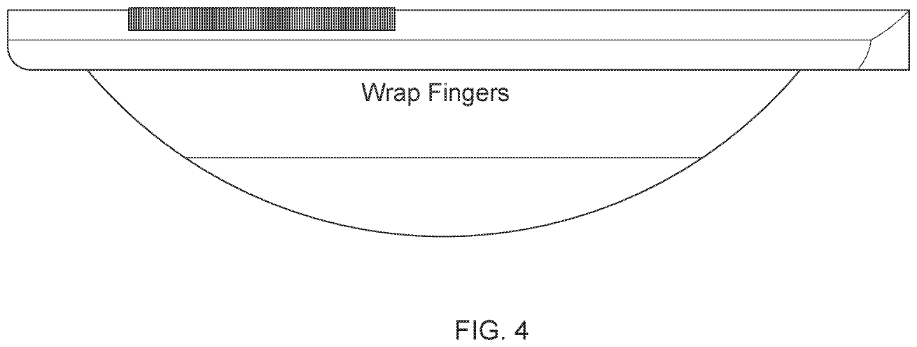

The rear side is fixed to the top side along the bottom surface of the top side offset the front side. The rear side is designed with a half ovular curved shape as seen in FIG. 4. The contoured shape of the semi-circular or ovular curved shape encourages the use to wrap their fingers around the shape of the device.

In one embodiment the rear side comprises a flared edge and a rear engraving. The flared edge, seen in FIG. 4, is positioned along the bottom side of the rear side that creates an outwards curved shape that allows the musician to place and secure the ends of their fingers. The rear engraving is positioned offset above the flared edge that has the words “Wrap Fingers”.

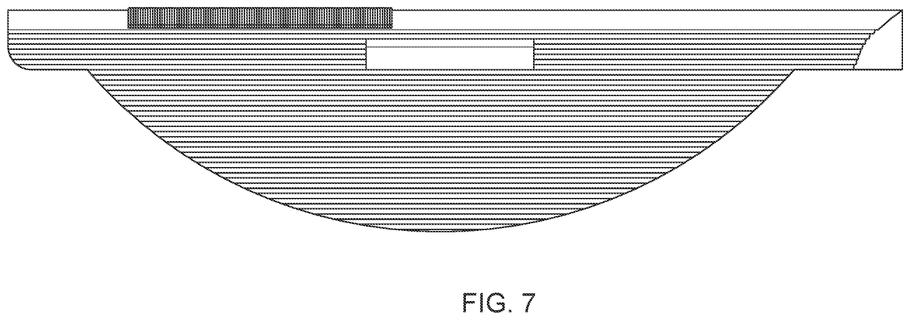

This instructs the user to place their fingers along the rear side of the present invention to properly hold the bow. In an alternative embodiment the rear side additionally comprises a finger grip that covers the entirety of the rear surface with a plurality of ridges to create a frictional surface as seen in FIG. 7.

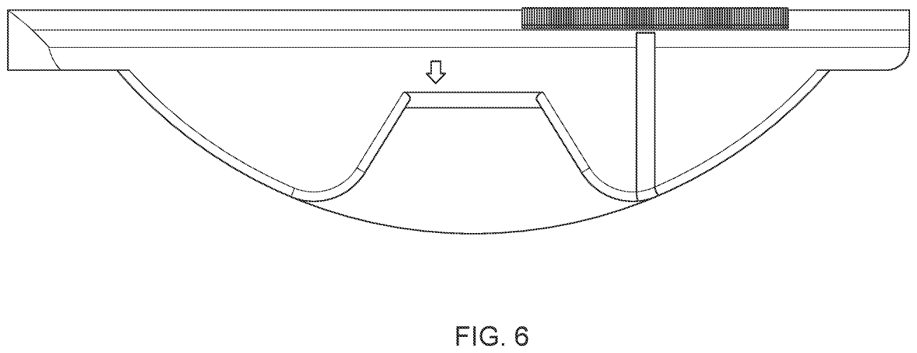

Further, the front side is designed with a symmetrical double ridged shape with a flat section in the middle for the thumb placement as seen in FIG. 6. In an alternative embodiment each component that contains wording will be designed with a different color. The components that would be color coordinated are the pinky wording with the label “Curl Pinky”, the thumb wording with the label “Bend Thumb” and the flared edge with the label “Wrap Finger”.

For example the pinky wording is a blue color, the thumb wording is a red color, and the flared edge is a green color with each color drawing attention to the specific area and allowing the different areas to be easily distinguishable allowing for quick identification of proper hand positioning. With all the components working in tandem with each other it can be seen that, the present invention is a bow hand training device for teaching orchestral students how to pronate the bow towards the strings while playing a string instrument.

In some embodiments, the present subject matter comes with a set of stickers to place on the bow hand training device.

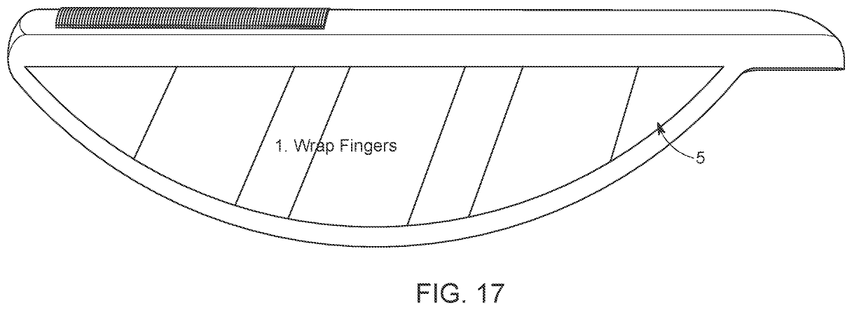

FIG. 17 shows a sticker removably affixed to the bow hand training device wherein the Wrap Fingers Sticker 5 indicates the first step is for the user to wrap their fingers, specifically their pointer, middle, and ringer finger around the bow hand training device.

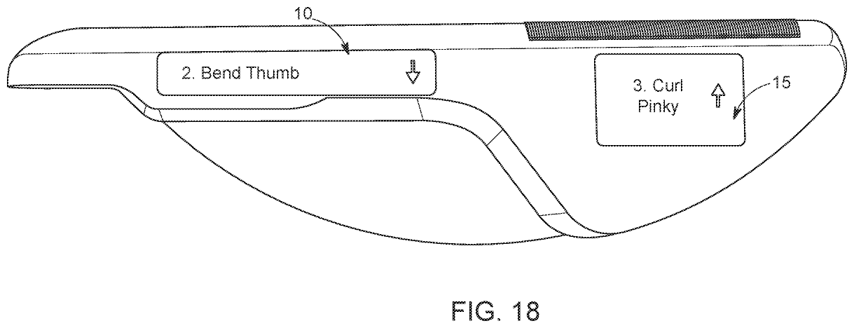

FIG. 18 shows a side perspective view of the bow hand training device with a removably attached sticker which indicates where the user's thumb should bend and where the user's pinky should curl. The Bend Thumb Sticker 10 and Curl Pinky Sticker 15 are affixed to the side of the bow hand training device.

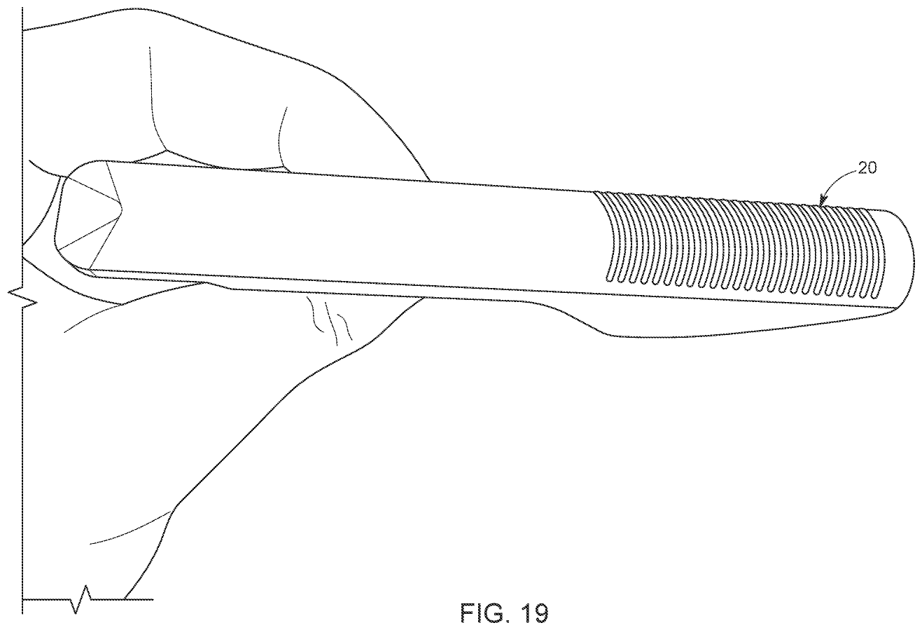

FIG. 19 shows a top perspective view of the bow hand training device wherein there are a plurality of ridges 20 to facilitate a better tactile feel for the curled pinky on top.

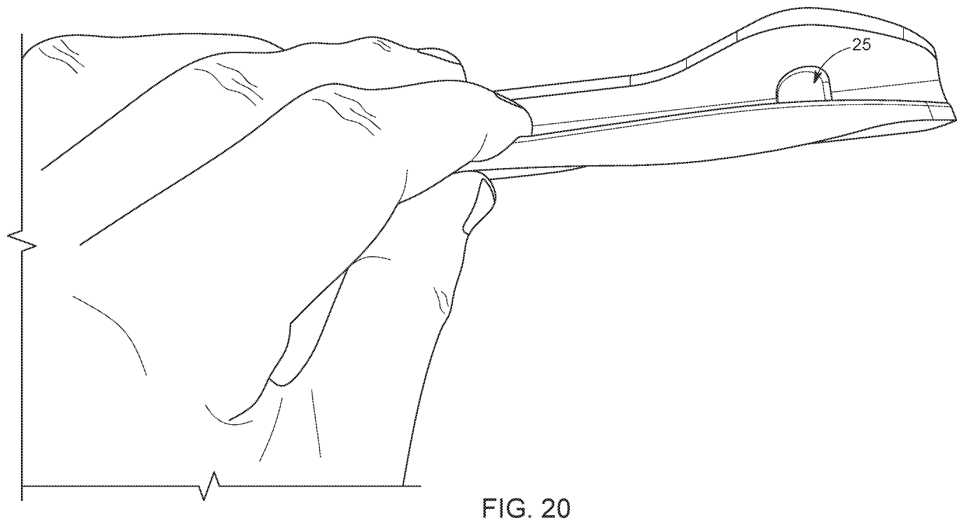

FIG. 20 shows a bottom perspective view of the bow hand training device wherein a ridge 25 embedded into the bottom surface helps facilitate the appropriate bow angle toward the violin's strings while in use.

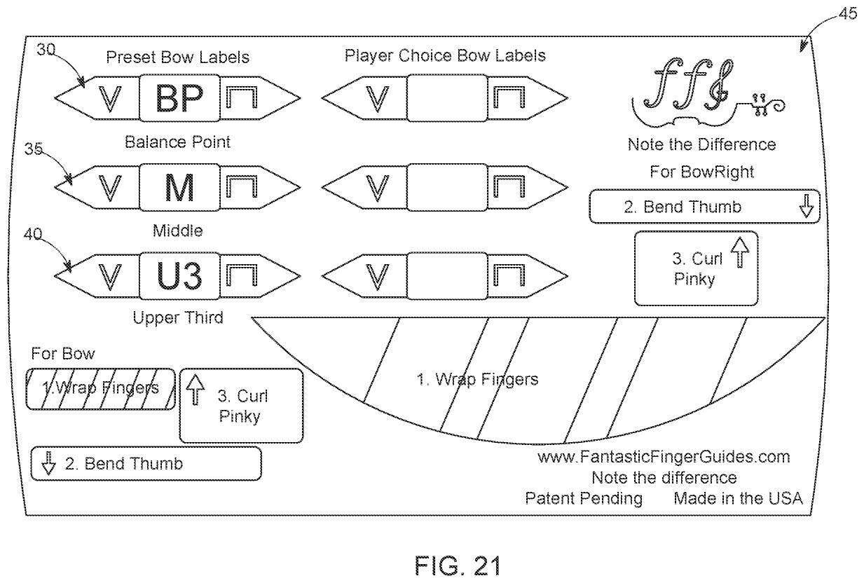

FIG. 21 shows a sticker sheet 45 which is designed to be attached to the bow hand training device as a training aid wherein the stickers are labeled in such a way that a novice player is able to mark on their bow where the balance point 30, middle point 35, and upper third 40 of the bow is located.

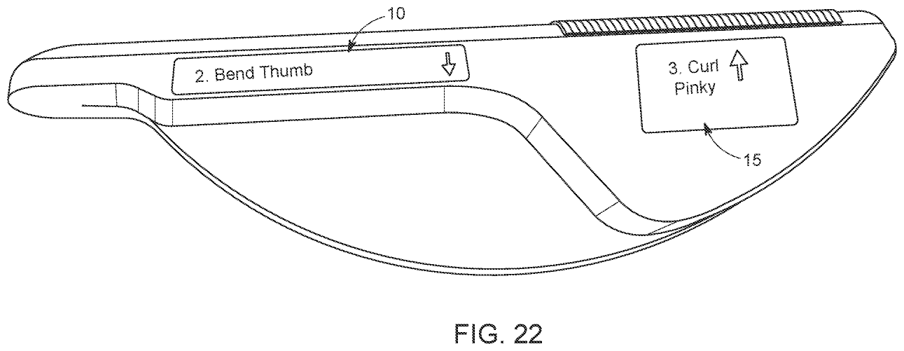

FIG. 22 shows a side perspective view of the preferred embodiment of the bow hand training device with an attached sticker to indicate where the user's thumb should bend and where the user's pinky should curl wherein the Bend Thumb Sticker 10 reminds the user to bend their thumb and the Curl Pinky Sticker 15 reminds the user to curl their pink on top of the plurality of ridges.

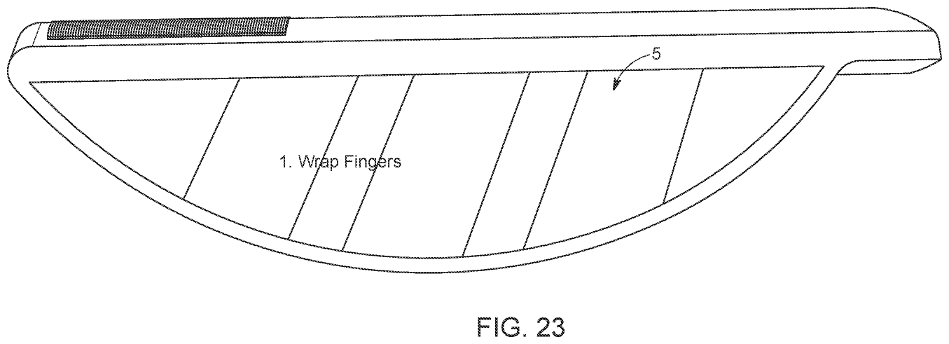

FIG. 23 shows a preferred embodiment of a side view of one embodiment of the bow hand training device with an attached sticker to indicate the angle the user's fingers should wrap around the bow hand training device wherein the Wrap Fingers Sticker 5 reminds the user to wrap their fingers around the training device.

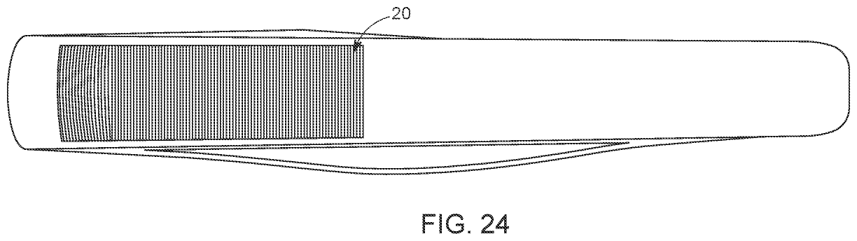

FIG. 24 is a top view of the preferred embodiment of the bow hand training device wherein a plurality of ridges 20 helps the user's pinky get a better grip on the top of the training device.

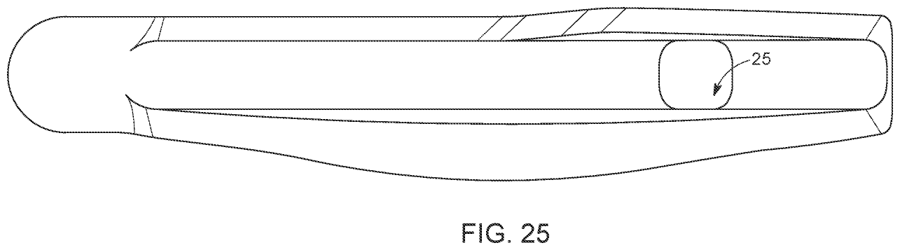

FIG. 25 is a bottom view of the preferred embodiment of the bow hand training device wherein ridge 25 orients the device in a manner that helps the user pronate the bow.

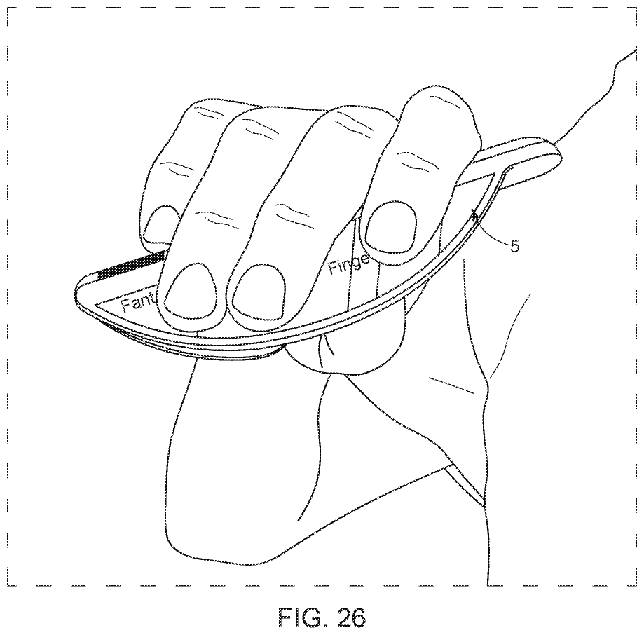

FIG. 26 is a side perspective view of the preferred embodiment of the bow hand training device being held by a user without the bow wherein the Wrap Finger Sticker 5 is affixed to the device.

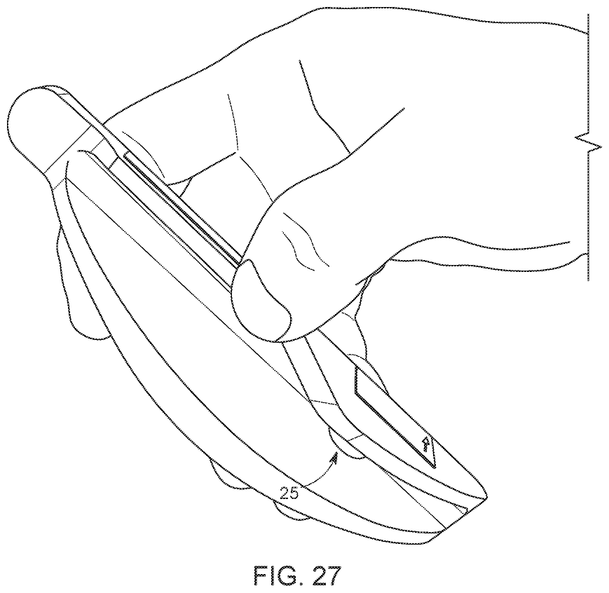

FIG. 27 is a bottom perspective view of the preferred embodiment of the bow hand training device being held by a user without the bow.

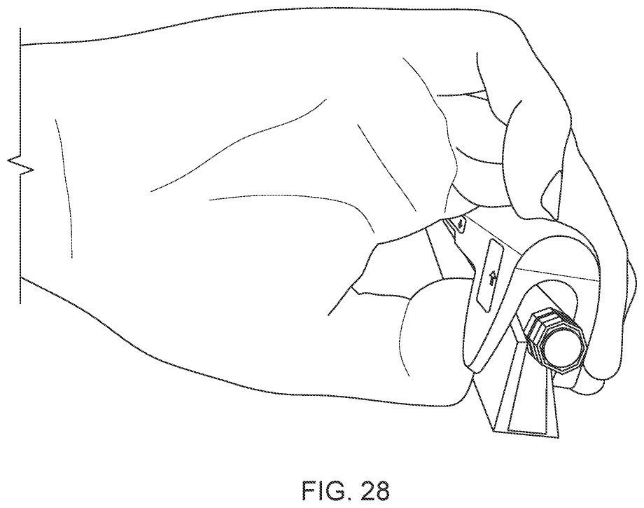

FIG. 28 is a rear perspective view of the preferred embodiment of the bow hand training device on a bow showing the Curled Pinky and grip location wherein the user is bending their thumb and curling their pinky.

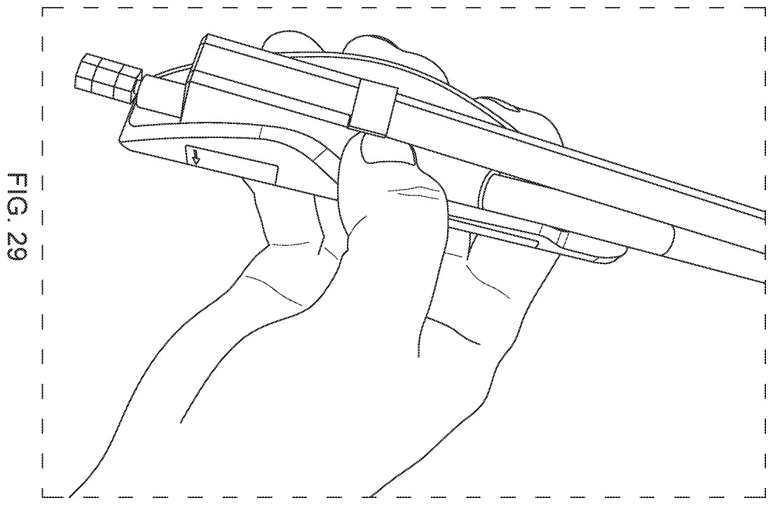

FIG. 29 is a bottom perspective view of the preferred embodiment of the bow hand training device being held by a user showing the bent thumb connecting the present invention to the bow.

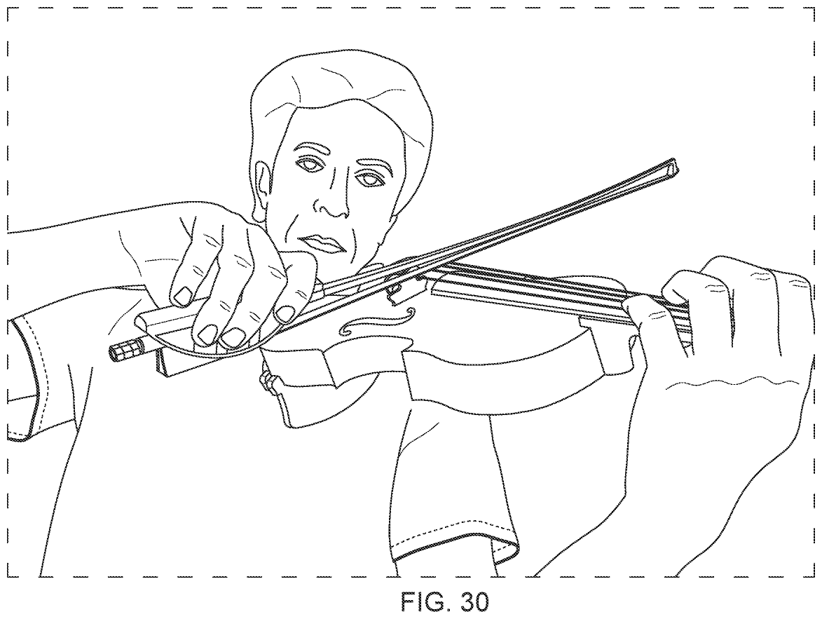

FIG. 30 shows a perspective view of the preferred embodiment of the bow hand training device in use.

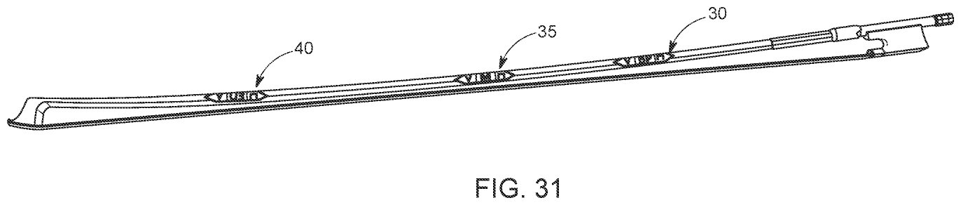

FIG. 31 shows a side view of the bow with the bow labels affixed to the bow wherein the balance point 30, middle point 35, and upper third 40 stickers are applied directly to the bow.

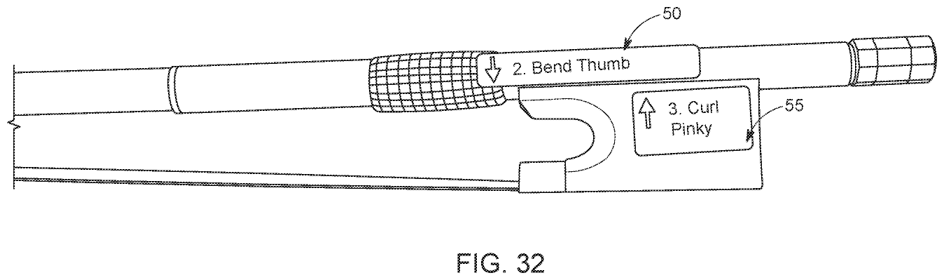

FIG. 32 shows a side view of the bow with the smaller Bend Thumb Sticker 50 and Curl Pinky Sticker 55 are affixed to the bow handle.

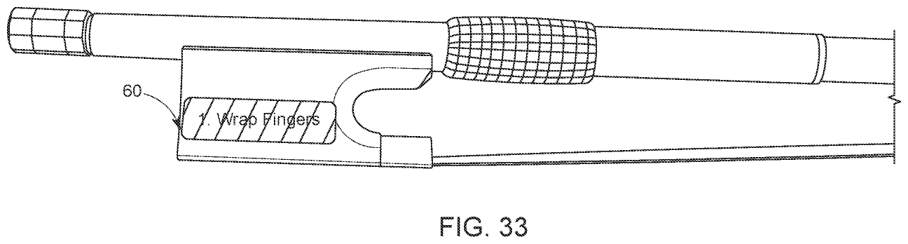

FIG. 33 shows a side view of the bow with the smaller Wrap Fingers Sticker 60 is affixed to the bow handle.

The sticker sheet comes with one set of stickers meant to be used on the present subject matter and when a player graduates from the bow training aid, the additional stickers may be removably affixed to the bow itself as a reminder of which fingers need to be wrapped, where the pinky needs to be curled, and how the thumb needs to be bent. This additional stickers are seen in FIG. 32 and FIG. 33.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A bow hand training device for teaching orchestral students how to pronate the bow toward the strings while playing comprising of an upper surface, two side surfaces and an underneath surface, a plurality of ridges, a ridge on the bottom surface, and a sticker sheet.

2. The bow hand training device as in claim 1, wherein one side surface has a semi-circular shape with a contour to encourage the user to wrap their fingers around the shape of the device.

3. The bow hand training device as in claim 1, wherein one side surface has a semi-circular shape with the Wrap Fingers Sticker on the training device.

4. The bow hand training device as in claim 1, wherein one side surface has a semi-circular shape with a cutout for the user to place and bend their thumb.

5. The bow hand training device as in claim 1, wherein one side surface has a semi-circular shape with a cutout with the Bend Thumb Sticker and Curl Pinky Sticker are affixed on the training device.

6. The bow hand training device as in claim 1, wherein one side surface has a semi-circular shape with a cutout has an arrow to indicate where the thumb should be located and one arrow to indicate where the pinky should be located.

7. The bow hand training device as in claim 1, wherein the upper surface of the has a plurality of ridges to create a tactile feel for the curled pinky to rest on.

8. The bow hand training device as in claim 1, wherein the underneath surface of the training device has a ridge embedded into the bottom surface that helps facilitate the appropriate bow angle toward the violin's strings while in use.

9. The bow hand training device as in claim 1, wherein the sticker sheet has a plurality of stickers to affix to the training device or directly onto the bow.
